(19) United States
(12) Patent Application Publication
(10) Pub. No.: US 2005/0100485 A1
(43) Pub. Date: May 12, 2005

(54) Device for filtering discharged air of a wet-type electrophotographic image forming apparatus

(76) Inventors: Jong-tae Kim, Seoul (KR); Young-sil Lee, Seoul (KR); Eun-sang Park, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/914,252

(22) Filed: Aug. 10, 2004

(30) Foreign Application Priority Data
Nov. 7, 2003 (KR) 2003-78730

(51) Int. Cl. B01D 53/34

(52) U.S. Cl. 422/177

(57) ABSTRACT

A device for filtering discharged air of a wet-type electrophotographic image forming apparatus capable of diffusing heat transmitted from a heater and an oxidation catalyst filter to prevent transformation of a casing of the device. The filtering device comprises a heater connected to a power unit of the image forming apparatus to generate heat. An oxidation catalyst filter is disposed adjacent to the heater to filter the discharged air through a chemical reaction with the discharged air. A filter casing holds the heater and the oxidation catalyst filter inside. A filtering device casing having the filter casing at a predetermined distance inside to form an air path through which the discharged air is drawn through a discharge path of the image forming apparatus. The air is discharged to the outside passing through the filter casing and a heat generation device connecting the filter casing to the filtering device casing, thereby preventing the heat of the heater from being transmitted to the filtering device casing.

### CROSS-REFERENCE TO RELATED APPLICATIONS

This application claims the benefit under 35 U.S.C.§ 119(a) of Korean Application No. 2003-78730, filed Nov. 7, 2003, in the Korean Intellectual Property Office, the entire disclosure of which is incorporated herein by reference.

### BACKGROUND OF THE INVENTION

1. Field of the Invention

The present invention relates to an image forming apparatus. More particularly, the present invention relates to a device for filtering harmful objects in the air which is generated and discharged during the fusing process of a wet-type electrophotographic image forming apparatus.

2. Description of the Related Art

In a general wet-type electrophotographic image forming apparatus 10, as shown in FIG. 1, a developing unit 13 forms a toner image on an image carrier 12 such as an organic photoconductive (OPC) drum having an electrostatic latent image thereon formed by a laser scanning apparatus (LSU) 11. The toner image is transferred to a paper P through a transfer unit 14, and is fused on the paper P by the heat and pressure at a fusing unit 15.

In a developer for the wet-type electrophotographic image forming apparatus 10, the toner is diluted by a liquid carrier such as a norpar, although others may be used. In the liquid carrier, components such as a pigment, a binder resin, and a charge director are scattered. The carrier evaporates generating a steam while the toner is fused on the paper P by high temperature and pressure of the fusing unit 15. The liquid carrier and the steam consist of hydrocarbon compounds which may be volatile organic compounds. Examples of materials that are volatile organic compounds usually include benzene, acetylene, gasoline, phenol, methanol, butanol, acetone, methylethyl ketone, and acetic acid. The volatile organic compounds co-existing in the air with a nitrogen oxide photochemically react due to sunlight, and photochemical oxidized substances such as ozone and peroxyacetyl nitrate (PAN) are generated. Therefore, the volatile organic compounds are undesireable in that they pollute the air and in some cases may be carcinogenic substances.

In order to filter the undesirable substances, the electrophotographic image forming apparatus comprises a filtering device 20, as shown in FIG. 1, which forcibly draws in and discharges the internal air of the image forming apparatus to the exterior of the image forming apparatus.

Referring to FIG. 2, the filtering device 20 comprises an oxidation catalyst filter 21, a heater 22 for heating the oxidation catalyst filter 21, a filter casing 23 for fixedly supporting the oxidation catalyst filter 21 and the heater 22, and a filtering device casing 24 for receiving the filter casing 23 therein.

The filter casing 23 is engaged with the filtering device casing 24 by a plurality of screws S. On a front of the filter casing 23, a cover 25 is engaged to tightly close the filtering device casing 24, and form a path in the filtering device casing 24. The path passes through the filter casing 23, for the suction of an air which includes the steam containing the carrier through a suction duct 26 formed at an upper part of the filter casing 23. Therefore, the air flowing in and out through the path contacts the oxidation catalyst filter 21 which is heated by the heater 22 up to approximately 150° C. to 400° C. Particles in the air are oxidized and disintegrated by the heat.

It is noted, however, that the filter casing 23 is generally made of a metal having a high thermal resistance, and the filtering device casing 24 is made of a resin also having a thermal resistance. The heat of the filter casing 23 transmitted from the heater 22, is transmitted to the filtering device casing 24 via a contact surface 23a of the filter casing 23, which contacts the filtering device casing 24. Since the oxidation catalyst filter 21 is heated up to approximately 150° C. to 400° C., the contact surface 23a can be transformed by the heat.

### SUMMARY OF THE INVENTION

An object of the present invention is to solve at least the above problems and or disadvantages and to provide at least the advantages described below. Accordingly, an object of the present invention is to provide a device for filtering air discharged from a wet-type electrophotographic image forming apparatus which has an improved structure to prevent a filtering device casing from being transformed by the heat of an oxidation catalyst filter.

In order to achieve the above-described aspects of the present invention, there is provided a device for filtering air discharged from a wet-type electrophotographic image forming apparatus. The air filtering device comprises a heater connected to a power unit of the image forming apparatus to generate heat, an oxidation catalyst filter disposed adjacent to the heater to filter air and entrained carrier vapor from the fusing unit by a chemical reaction, and a filter casing mounting the heater and the oxidation catalyst filter inside. The filtering device casing holds the filter casing at a predetermined gap to form an air path through which the air and the carrier vapor is drawn through a discharge path of the image forming apparatus. The carrier vapor is discharged to the outside past the filter casing and a heat generation. device connecting the filter casing to the filtering device casing, thereby preventing the heat of the heater from being transmitted to the filtering device casing.

In an exemplary embodiment of the present invention, the heat generation device comprises a support member penetrating the oxidation catalyst filter and the filter casing, with both ends of the support member connected to the filtering device casing, and a heat conduction member disposed in the support member.

The heat conduction member is disposed in the air path in a space between the filter casing and the filtering device casing.

The heat conduction member is connected to the support member, and can be exposed to the exterior of the filtering device casing.

The heat conduction member comprises at least one board member which is connected to the support member for heat conduction. The heat conduction member preferably comprises at least one metal selected from the group consisting of copper, aluminum, brass, or steel.

### BRIEF DESCRIPTION OF THE DRAWINGS

The above object and other features of the present invention will become more apparent by describing in detail a preferred embodiment thereof with reference to the attached drawings.

FIG. 1 is a view schematically showing a conventional wet-type electrophotographic image forming apparatus having a device for filtering a discharged air;

FIG. 2 is an exploded perspective view schematically showing the conventional filtering device;

FIG. 3 shows an exploded view of a filtering device casing of the wet-type electrophotographic image forming apparatus having a heat generation device according to an embodiment of the present invention;

FIG. 4 is a schematic view of the heat generation device according to an embodiment of the present invention;

FIG. 5 is a perspective view of the main part of FIG. 4 showing the operation of the heat generation device according to an embodiment of the present invention;

FIG. 6 shows the operation of the heat generation device exposed to the exterior of the filtering device casing according to another embodiment of the present invention; and

FIG. 7 is a perspective view of the main part of FIG. 6, showing the operation of the heat generation device according to another embodiment of the present invention.

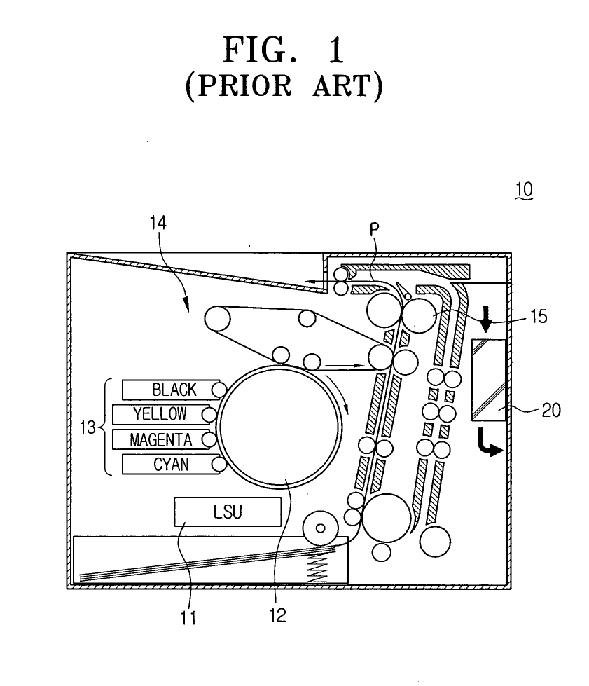

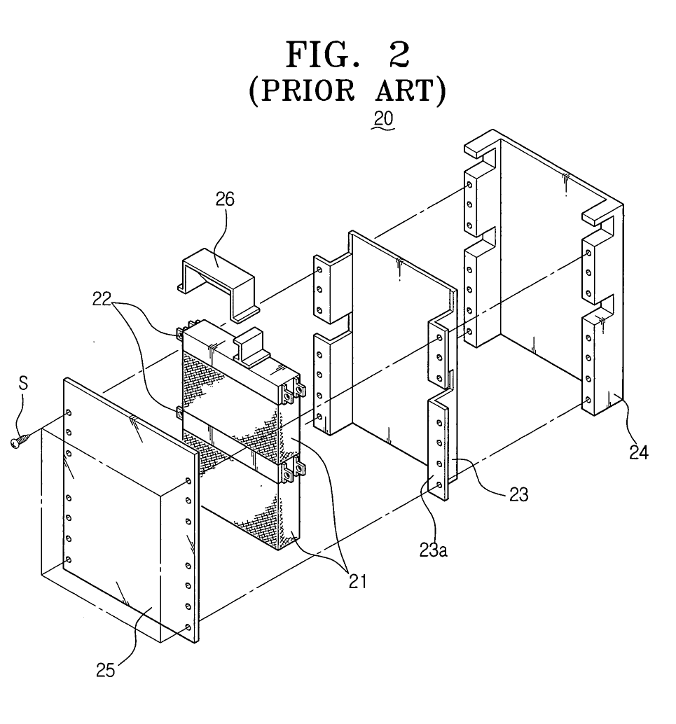

### DETAILED DESCRIPTION OF THE EXEMPLARY EMBODIMENTS

Hereinafter, the present invention will be described in detail with reference to the accompanying drawing figures. In the following description, it should be understood that the same drawing reference numerals are used for the same or similar elements throughout the drawings. The matters defined in the description such as a detailed construction and elements are provided to assist in a comprehensive understanding of the invention. However, it is apparent that the present invention can be carried out with various changes to the examples described herein. Also, well-known functions or constructions are not described in detail since they would obscure the invention in unnecessary detail.

A device for filtering discharged air 120 according to an embodiment of the present invention operates in the same manner as conventional devices described above. Therefore, the filtering operation, which is irrelevant to the aspects of the present invention will be omitted for conciseness.

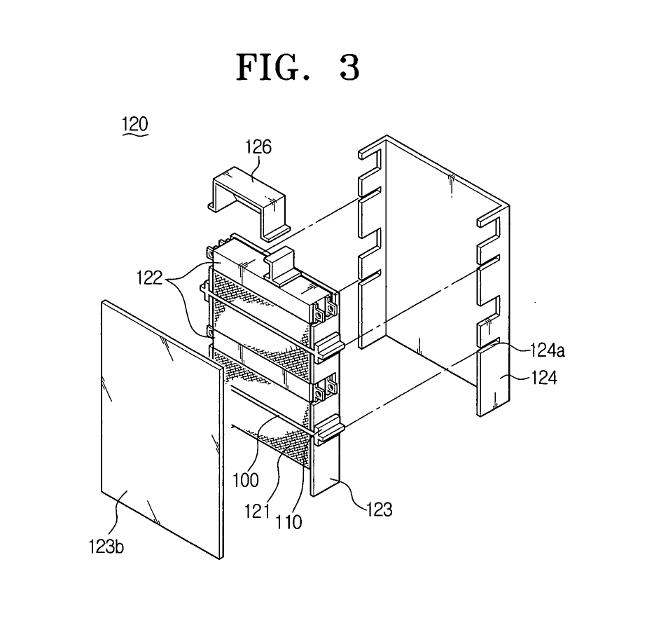

As shown in FIG. 3, the filtering device 120 comprises an oxidation catalyst filter 121, a heater 122, and a filter casing 123 that includes the oxidation catalyst filter 121 and the heater 122 which are abutted to each other. Outside of the filter casing 123, a filtering device casing 124 is formed at a predetermined distance, preferably, at about 2.5 to 3.5 mm from the filter casing 123. A heat generation device, formed between the filter casing 123 and the filtering device casing 124, has a support member 100 and a heat conduction member 110.

The filter casing 123 and the filtering device casing 124 are fixed to each other by the support member 100. The support member 100 penetrates the oxidation catalyst filter 121, as shown in FIG. 3, with both ends engaged with the filtering device casing 124. A through hole 124a, corresponding to the support member 100, is formed in the filtering device casing 124 and is slidingly engaged with the support member 100. On a front of the filtering device casing 124, a front cover 123b is engaged to cover the oxidation catalyst filter 121 and the heater 122.

Accordingly, air containing a carrier is drawn in through a suction duct 126 as shown in FIG. 3. The drawn-in air, which may include potentially harmful substances, contacts the oxidation catalyst filter 121 that has been heated by the heater 122 to approximately 150° C. to 400° C. is oxidized and disintegrated by the heat.

The heat of the heater 122 is transmitted to the support member 100, thereby heating the oxidation catalyst filter 121.

The support member 100 is preferably formed by a material of low heat conductivity. Since the filter casing 123 and the filtering device casing 124 are connected by the support member 100 having a narrow contact surface, the heat transmitted to the filtering device casing 124 should be minimal. Additionally, one or more heat conduction member 110 may be preferably connected to both ends of the support member 100 to diffuse the heat transmitted through the support member 100. The heat conduction member 110 may be formed by a board-shaped metal of high heat conductivity. The metal preferably comprises at least one metal selected from the group consisting of copper, aluminum, brass, and steel.

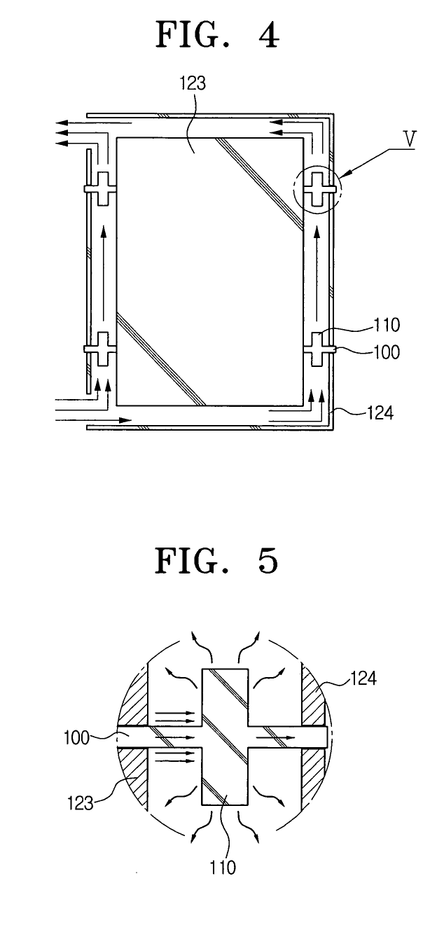

Hereinafter, the operation of the filtering device of the wet-type electrophotographic image forming apparatus having a device for preventing high heat transmission according to an embodiment of the present invention, will be described with reference to FIGS. 4 and 5.

FIG. 4 is a schematic view of the filter casing 123 and the filtering device casing 124 connected to each other by the support member 100. The filtering device casing 124 may include an air path open at upper and lower parts thereof to allow air to flow to the outside of the image forming apparatus.

In FIG. 4, the filter casing 123 is heated by a plurality of the heaters 122 (shown in FIG. 3). In an embodiment of the invention, the filter casing 123 near the heater 122 has a higher temperature than the filter casing 123 near the oxidation catalyst filter 121. Therefore, in a space between the filter casing 123 and the filtering device casing 124, an air flows in a direction of the arrows in FIG. 4. Accordingly, air can flow in the space from the outside since the outside has a relatively lower temperature than the space between the filter casing 123 and the filtering device 124.

At both ends of the support member 100, one or more heat conduction member 110 is connected to be exposed to the air path as shown in FIG. 5. The heat is diffused by the heat conduction member 110 after being transmitted to the support member 100 that penetrates the oxidation catalyst filter 121, which is heated by the heater 122. Therefore, the heat transmitted to the filtering device casing 124 can be reduced.

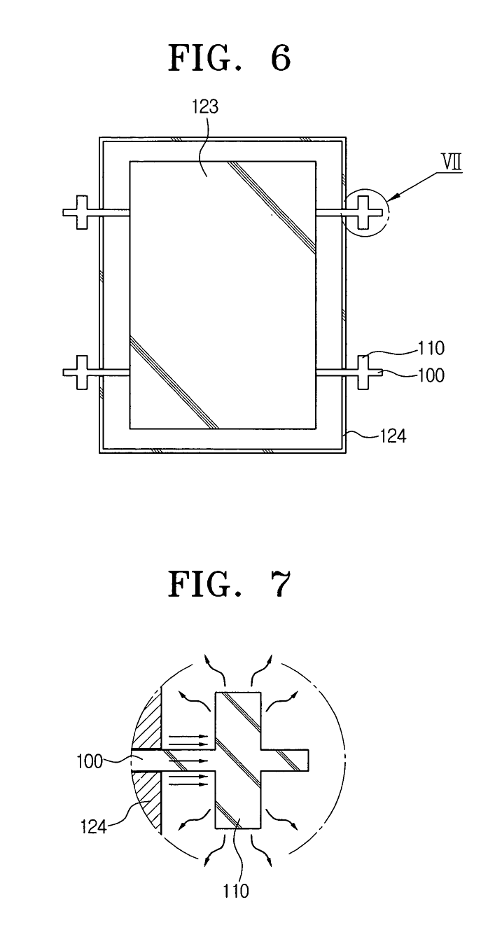

As shown in FIG. 6, the heat conduction member 110 can be exposed to the exterior of the filtering device casing 124 to directly contact the outside air. In this embodiment, since the heat conduction member 110 generates the heat being directly contacted with the outside air, as shown in FIG. 7, the air path of FIG. 4 is not necessary the flow path of the air in the space between the filter casing 123 and the filtering device casing 124.

According to one preferred embodiment of the present invention, the heat conduction member 110 is comprised of at least one board member connected to the support member 100. However, a plurality of the board members can be mounted to the support member 100 in a general cooling fin arrangement, to enlarge the area contacting the air.

As can be appreciated from the above description of the device for filtering the discharged air of the wet-type electrophotographic image forming apparatus, since the heat of the heater 122 and the oxidation catalyst filter 121 is diffused by the heat generation device, the high temperature of approximately 150° C. to 400° C., is not directly transmitted to the filtering device casing 124. As a result, the thermal transformation of the filtering device casing 124 can be prevented.

While the invention has been shown and described with reference to certain preferred embodiments thereof, it will be understood by those skilled in the art that various changes in form and details may be made therein without departing from the spirit and scope of the invention as defined by the appended claims.

1. A device for filtering air discharged from a wet-type electrophotographic image forming apparatus, comprising:
a heater connected to a power unit of the image forming apparatus to generate heat;
an oxidation catalyst filter disposed adjacent to the heater to filter air and entrained carrier vapor from a fusing unit through a chemical reaction;
a filter casing mounting the heater and the oxidation catalyst filter inside said filter casing;
a filtering device casing having therein said filter casing at a predetermined gap to form an air path through which the air and the carrier vapor is drawn through a discharge path of said image forming apparatus, and is discharged to the exterior of said image forming apparatus past the filter casing; and
a heat generation device connecting the filter casing to the filtering device casing preventing the heat of the heater from being transmitted to the filtering device casing.

2. The filtering device of claim 1, wherein the heat generation device comprises:
a support member penetrating the oxidation catalyst filter and the filter casing, with both ends connected to the filtering device casing; and
a heat conduction member disposed in the support member.

3. The filtering device of claim 2, wherein the heat conduction member is disposed on the air path in a space between the filter casing and the filtering device casing.

4. The filtering device of claim 2, wherein the heat conduction member is exposed out of the filtering device casing.

5. The filtering device of claim 2, wherein the heat conduction member comprises at least one board member which is connected to the support member for heat conduction.

6. The filtering device of claim 3, wherein the heat conduction member comprises at least one board member which is connected to the support member for heat conduction.

7. The filtering device of claim 4, wherein the heat conduction member comprises at least one board member which is connected to the support member for heat conduction.

8. The filtering device of claim 2, wherein the heat conduction member is formed from at least one metal selected from the group consisting of copper, aluminum, brass, and steel.

9. The filtering device of claim 3, wherein the heat conduction member is formed from at least one metal selected from the group consisting of copper, aluminum, brass, and steel.

10. The filtering device of claim 4, wherein the heat conduction member is formed from at least one metal selected from the group consisting of copper, aluminum, brass, and steel.
